(19) United States
(12) Patent Application Publication
(10) Pub. No.: US 2008/0297700 A1
(43) Pub. Date: Dec. 4, 2008

(54) Liquid crystal display and its backlight module and light-emitting module

(75) Inventors: Chih-Hao Yu, Taoyuan Hsien (TW); Nai-Yueh Liang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/889,131

(22) Filed: Aug. 9, 2007

(30) Foreign Application Priority Data
Jun. 1, 2007 (TW) 096119779

(51) Int. Cl. G02F 1/13357; F21V 9/08

(52) U.S. Cl. 349/68; 362/231

(57) ABSTRACT

A light-emitting module includes a plurality of lamp units and a plurality of LED units. The lamp unit generates first non-white colored light. The LED unit generates second colored light. Each LED unit is disposed between the lamp units. The first non-white colored light and the second colored light are mixed to generate third colored light. A backlight module and a liquid crystal display (LCD) are also disclosed.

### CROSS REFERENCE TO RELATED APPLICATIONS

This Non-provisional application claims priority under 35 U.S.C. §119(a) on Patent Application No(s). 096119779 filed in Taiwan, Republic of China on Jun. 1, 2007, the entire contents of which are hereby incorporated by reference.

### BACKGROUND OF THE INVENTION

1. Field of Invention

The invention relates to a light-emitting module, a backlight module and a liquid crystal display (LCD).

2. Related Art

The liquid crystal display (LCD) panels lack the self-lighting property, so the backlight modules have become an important subject in the development of the LCD technology. In the prior art, a cold cathode fluorescent lamp (CCFL) has the advantages of the low cost and high lighting efficiency, and is thus widely adopted as a light source for the backlight module. The lighting principle of the CCFL is to generate ultra-violet rays by way of high-voltage electrode discharge, and the ultra-violet rays excite red, green and blue fluorescent materials of the lamp. Then, the fluorescent materials respectively emit red, green and blue colored light, which can be mixed to produce the white light.

An upper portion of FIG. 1 is a schematic illustration showing wavelength ranges of light rays emitted from a white-light CCFL. A lower portion of FIG. 1 is a schematic illustration showing wavelength ranges of light rays emitted from red, green and blue light emitting diodes (LEDs). As shown in the upper portion of FIG. 1, W1, W2 and W3 respectively represent a red light band, a green light band and a blue light band of the CCFL. The white-light CCFL has red, green and blue fluorescent materials respectively emitting red, green and blue light, which are mixed to form white light. In the lower portion of FIG. 1, W4, W5 and W6 respectively represent red, green and blue light bands outputted from the LEDs. To compare with the upper portion and the lower portion of FIG. 1, the bands W1, W2 and W3 of each colored light in the white-light CCFL have the peaks P1 to P3 of the main colored light as well as the peaks P4 to P11 of the other unnecessary colored light. Thus, the saturation of the main colored light is insufficient and the display gamut range is reduced.

In addition, the energy of the ultra-violet ray in the CCFL is about 4.88 eV (electron volts). The energy is about 1.96 eV after the red fluorescent material is excited to emit light. Hence, the energy loss ratio is about (4.88−1.96)/4.88×100%=59.8%.

In addition, the energies, which are generated after the green and blue fluorescent materials are excited to emit light, are 2.33 eV and 2.7 eV, respectively. Therefore, the energy loss ratios are respectively 52.2% and 43.6%. Correspondingly, the energy loss ratio of the red fluorescent material is also higher than those of the green and blue fluorescent materials.

To improve the above-mentioned problem, a red LED is added to the backlight module. The highly saturated red light outputted from the red LED can enhance the color saturation of the red light outputted from the backlight module.

In the conventional improved method, however, the CCFL for outputting the white light still serves as the main lighting unit. Thus, the problem of energy loss of the red fluorescent material still cannot be solved. Furthermore, the CCFL for outputting the white light still outputs the red light with the insufficient saturation so that the red LED cannot function normally.

Therefore, it is an important subject to provide a lighting unit, a backlight module and a LCD capable of enhancing the color saturation and reducing the energy loss.

### SUMMARY OF THE INVENTION

In view of the foregoing, the invention is to provide a lighting unit, a backlight module and a LCD with the enhanced color saturation and the reduced energy loss.

To achieve the above, the invention discloses a light-emitting module, which includes a plurality of lamp units and a plurality of LED units. The lamp units generate a first non-white colored light, and the LED units generate a second colored light. Each of the LED units is disposed between the lamp units. The first non-white colored light and the second colored light are mixed to generate a third colored light.

To achieve the above, the invention also discloses a backlight module, which includes a housing, a plurality of lamp units and a plurality of LED units. The housing has a first surface and a second surface oppositely disposed to the first surface. The lamp units are positioned in the housing and disposed on the first surface. Each of the lamp units generates a first non-white colored light. The LED units are disposed between the lamp units for generating a second colored light. The first non-white colored light and the second colored light are complementary and mixed to generate a third colored light.

To achieve the above, the invention further discloses a liquid crystal display (LCD), which includes a LCD panel and a backlight module disposed on one side of the LCD panel. The backlight module includes a housing, a plurality of lamp units and a plurality of LED units. The housing has a first surface and a second surface. The lamp units are positioned in the housing and disposed on the first surface for generating a first non-white colored light. The LED units are disposed between the lamp units for generating a second colored light. The first non-white colored light and the second colored light are complementary and mixed to generate third colored light.

As mentioned above, the CCFL and the LED are simultaneously disposed in the light-emitting module or the backlight module according to the invention, and the colors of the light rays outputted from the CCFL and LED are complementary.

Compared with the prior art, since the colors of the light rays outputted from the CCFL and LED are complementary, mixing the colors of light can form a white light. Thus, the LED can develop the function effectively, and the energy loss generated by the unessential fluorescent material in the CCFL may also be reduced. Therefore, the overall lighting efficiency of the light-emitting module can be enhanced, and the color saturation and the gamut range also be enhanced when the LCD is displaying.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing wavelength ranges of light rays emitted from red, green and blue LEDs and a white light CCFL;

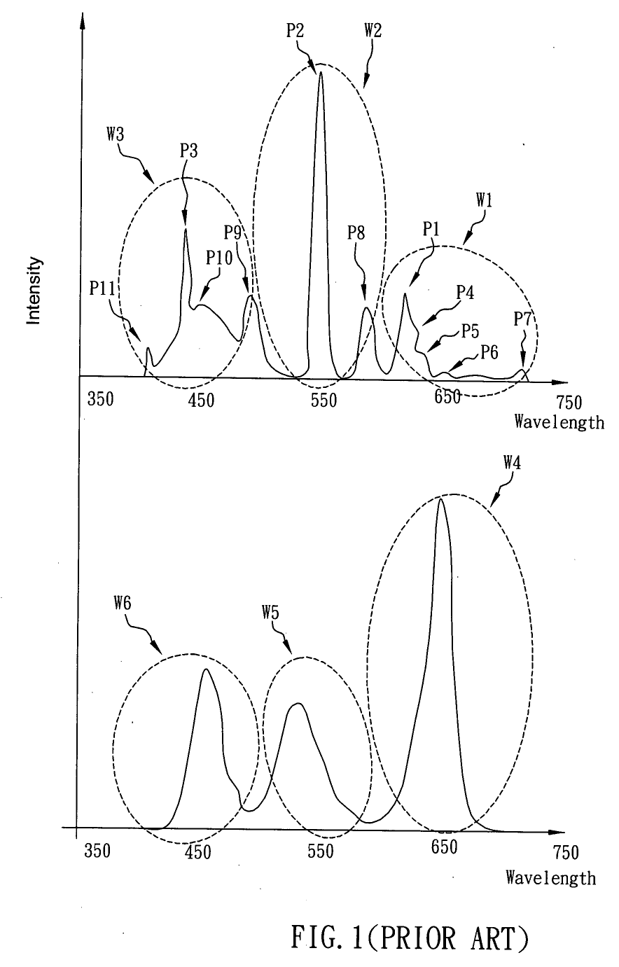

FIG. 2 is a schematic illustration showing a LCD according to a first embodiment of the invention;

FIG. 3 is a schematic illustration showing a LCD according to another aspect of the first embodiment of the invention; and

FIG. 4 is a schematic illustration showing a LCD according to a second embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

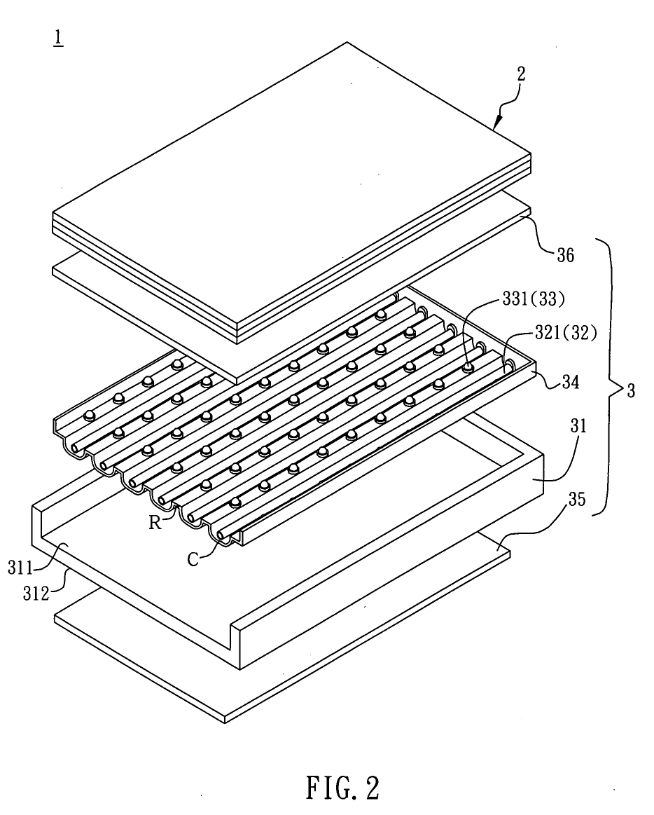

Referring to FIG. 2, a LCD 1 according to a first embodiment of the invention includes a LCD panel 2 and a backlight module 3. The backlight module 3 is disposed under the LCD panel 2 and has a housing 31, a lamp unit 32 and a LED unit 33. The housing 31 has a first surface 311 and a second surface 312, the lamp unit 32 is disposed opposite to the first surface 311 of the housing 31, and the LED unit 33 is disposed adjacent to the lamp unit 32.

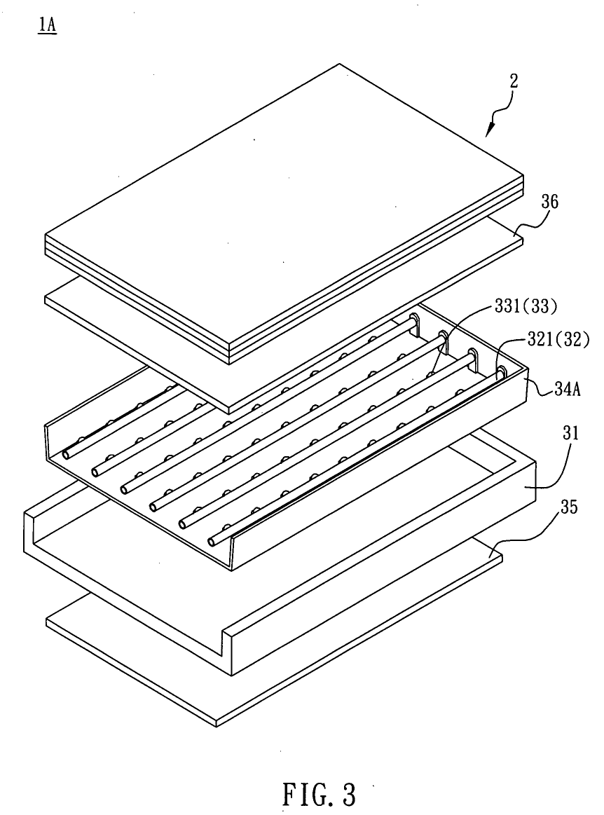

Also, in this embodiment, the backlight module 3 further includes a reflecting unit 34, a circuit board 35 and a diffuser 36. The reflecting unit 34 is disposed between the first surface 311 of the housing 31 and the lamp unit 32 and has a bottom surface, which is an uneven surface 341. The lamp unit 32 is disposed in a concave portion C on the uneven surface 341, while the LED unit 33 is disposed in a convex portion R on the uneven surface 341. In addition, as shown in a LCD 1A of FIG. 3, the bottom surface of a reflecting unit 34A may also be an even surface so that the manufacturing cost of the reflecting unit 34A is reduced.

As shown in FIG. 2, the circuit board 35 may be disposed on the second surface 312 of the housing 31, or disposed between the first surface 311 of the housing 31 and the reflecting unit 34. In this embodiment, the circuit board 35 is disposed on the second surface 312 of the housing 31, and the circuit board 35 is electrically connected to the lamp unit 32 and the LED unit 33. In addition, if the circuit board 35 is disposed between the reflecting unit 34 and the lamp unit 32, the LEDs of the LED unit 33 may also be electrically connected to the circuit board 35 by surface mount technology (SMT) method. However, the LEDs may also be electrically connected to the circuit board 35 according to other manners.

The diffuser 36 is disposed on the lamp unit 32 and the LED unit 33, and makes the light outputted from the lamp unit 32 and the LED unit 33 become more uniform by way of scattering.

In order to enhance the saturation of each colored light among the white light formed by mixing the light of the lamp unit 32 and the LED unit 33, a CCFL 321 of the lamp unit 32 may cooperate with a LED 331 of the LED unit 33.

In this embodiment, the CCFL 321 only has the green and blue fluorescent materials, so the light outputted to form a cyan light by mixing the green light and the blue light. In order to make the mixed light outputted from the lamp unit 32 and the LED unit 33 become the white light, the LED 331 in the LED unit 33 is a red LED for outputting light, which has a wavelength range from 600 to 700 nm and is complementary to the yellow light.

Compared the cyan-light CCFL 321 of this embodiment with the conventional white-light CCFL, the total energy loss in the conventional white-light CCFL is about

⅓×59.8%+⅓×52.2%+⅓×43.6%=51.87%.

In addition, the total energy loss in the cyan-light CCFL 321 of this embodiment is about

½×52.2%+½×43.6%=47.9%.

Thus, about 4% of energy loss is reduced after the red fluorescent material is eliminated.

In addition, as for the contribution degree to the human eyes, the ratio of the contribution degree of the red light to that of the green light and that of the blue light in the conventional white-light CCFL is about

(2×:5×:1×),

wherein x is a constant. In the cyan-light CCFL 321 of this embodiment, the energy received by the green and blue fluorescent materials is increased by ½ because the red fluorescent material is removed. Thus, the ratio of the contribution degree of the green light to that of the blue light is also increased to

7.5×:1.5×.

The contribution degree of the red light may be adjusted using the red LED 331. In order to keep the same ratio, the ratio of the contribution degree of the red light to that of the green light and that of the blue light may be increased to

3×:7.5×:1.5×.

Thus, the contribution degrees of the green and blue light are increased under the same driving power. In other words, if the original contribution degree is kept, the power-saving effect can be achieved using the lower driving power.

In addition, when the CCFL 321 only has the red and blue fluorescent materials, the CCFL 321 outputs a magenta light, and the LED 331 is changed to a green-light diode for outputting light having a wavelength range from 500 to 580 nm. When the CCFL 321 only has the red and green fluorescent materials, the CCFL 321 outputs a yellow light, and the LED 331 is changed to a blue-light diode for outputting light having a wavelength range from 400 to 500 nm.

In brief, one portion of three primary colors (red, green and blue) is provided by the CCFL, and the LED provides the other portion of the three primary colors. Then, the two portions are mixed to form the white light.

In the above-mentioned embodiment, the lamp unit 32 and the LED unit 33 may also be incorporated and thus regarded as a light-emitting module, which may be used individually.

### Second Embodiment

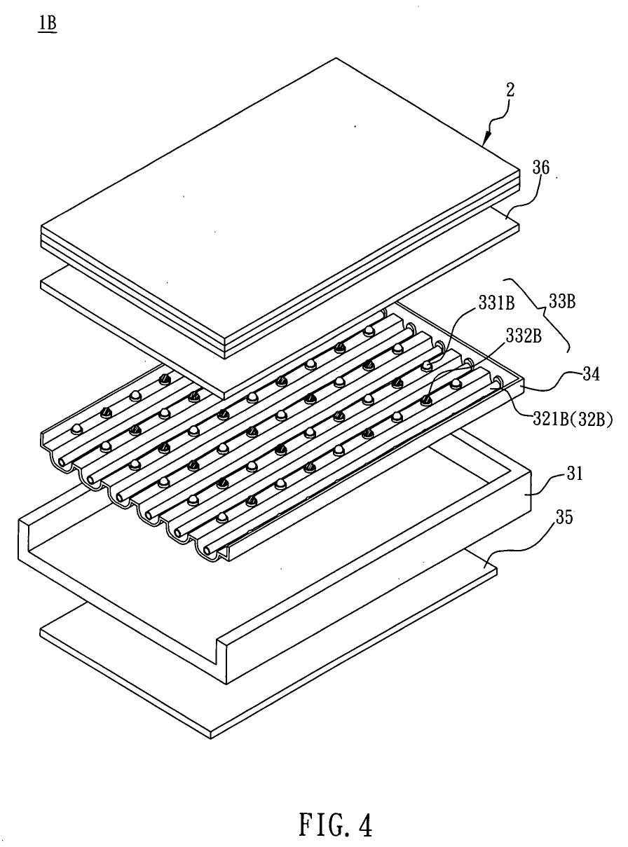

As shown in FIG. 4, a LCD 1B according to a second embodiment of the invention is different from the LCD of the first embodiment in that a CCFL 321B only has two colored fluorescent materials, and a LED unit 33B has two LEDs 331B and 332B for outputting different colors of light.

If the CCFL 321B is the red fluorescent material, the CCFL 321B outputs the red light, and the LEDs 331B and 332B respectively output the green light and the blue light. The three colors of light are then mixed to form the white light.

Also, if the CCFL 321B is the green fluorescent material, the CCFL 321B outputs the green light, and the LEDs 331B and 332B respectively output the red light and the blue light. The three colors of light may also be mixed to form the white light.

In addition, if the CCFL 321B is the blue fluorescent material, the CCFL 321B outputs the blue light, and the LEDs 331B and 332B respectively output the red light and the green light. The three colors of light may also be mixed to form the white light.

In summary, the CCFL and the LED are simultaneously disposed in the light-emitting module or the backlight module according to the invention. Also, the color of the fluorescent material in the CCFL can be adjusted, and the LEDs with different colors are provided, and the colors of the outputted light rays are complementary colors.

Compared with the prior art, two different fluorescent materials or one fluorescent material is disposed in the CCFL of the invention so that the CCFL outputs the light ray which is not white, and one LED or two LEDs are provided to output the light which is complementary to that the light outputted by the CCFL. Then, the while light can be formed by mixing the colors of light. Thus, the LED can develop the function effectively, and the energy loss generated by the unessential fluorescent material in the CCFL may also be reduced. Therefore, the overall lighting efficiency of the light-emitting module can be enhanced, and the color saturation and the gamut range are enhanced when the LCD is displaying. In addition, the contribution degree of each colored light to human eyes can be enhanced while the power can be saved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting module comprising:
a plurality of lamp units for generating a first non-white colored light; and
a plurality of LED units for generating a second colored light, wherein the LED units are disposed between the lamp units, and the first non-white colored light and the second colored light are mixed to generate a third colored light.

2. The light-emitting module according to claim 1, wherein the first non-white colored light and the second colored light are complementary colors.

3. The light-emitting module according to claim 1, wherein each of the lamp units comprises a first fluorescent material for generating the first non-white colored light.

4. The light-emitting module according to claim 3, wherein:
the second colored light is generated by mixing a green light with a blue light when the first non-white colored light is a red light;
the second colored light is generated by mixing a red light with a blue light when the first non-white colored light is a green light; or
the second colored light is generated by mixing a red light with a green light when the first non-white colored light is a blue light.

5. The light-emitting module according to claim 3, wherein the lamp unit further comprises a second fluorescent material, and the lamp unit generates the first non-white colored light by the first fluorescent material and the second fluorescent material.

6. The light-emitting module according to claim 5, wherein
the first non-white colored light is a cyan light, a magenta light or a yellow light.

7. The light-emitting module according to claim 6, wherein:
a wavelength of the second colored light ranges from 600 to 700 nanometers when the first non-white colored light is the cyan light;
a wavelength of the second colored light ranges from 500 to 580 nanometers when the first non-white colored light is the magenta light; and
a wavelength of the second colored light ranges from 400 to 500 nanometers when the first non-white colored light is the yellow light.

8. The light-emitting module according to claim 1, wherein the LED unit comprises a first LED and a second LED are mixed for generating the second colored light.

9. The light-emitting module according to claim 1, wherein the lamp unit comprises a CCFL, and the third colored light is a white light.

10. A backlight module comprising:
a housing having a first surface and a second surface opposite to the first surface;
a plurality of lamp units disposed on the first surface of the housing and generating a first non-white colored light; and
a plurality of LED units disposed between the lamp units for generating a second colored light, wherein the first non-white colored light and the second colored light are mixed to generate a third colored light.

11. The backlight module according to claim 10, wherein each of the lamp units comprises at least one fluorescent material for generating the first non-white colored light.

12. The backlight module according to claim 10, wherein each of the LED units comprises at least one light-emitting diode for generating the second colored light.

13. The backlight module according to claim 10, further comprising:
a reflecting unit disposed between the first surface of the housing and the lamp unit;
a circuit board electrically connected to the lamp unit and the LED unit and disposed between the first surface of the housing and the reflecting unit or on the second surface of the housing; and
a diffuser disposed above the lamp unit and the LED unit.

14. The backlight module according to claim 13, wherein the LED unit is electrically connected to the circuit board by surface mount technology.

15. The backlight module according to claim 13, wherein the reflecting unit has a bottom surface, and the bottom surface is a plane surface or has a concave portion and a convex portion connected to the concave portion.

16. The backlight module according to claims 10, wherein the lamp unit comprises a CCFL, and the third colored light is a white light.

17. The backlight module according to claim 10, wherein:
the second colored light is generated by mixing a green light with a blue light when the first non-white colored light is a red light;
the second colored light is generated by mixing a red light with a blue light when the first non-white colored light is a green light; or
the second colored light is generated by mixing a red light with a green light when the first non-white colored light is a blue light.

18. The backlight module according to claim 10, wherein:
a wavelength of the second colored light ranges from 600 to 700 nanometers when the first non-white colored light is a cyan light;
a wavelength of the second colored light ranges from 500 to 580 nanometers when the first non-white colored light is a magenta light; and
a wavelength of the second colored light ranges from 400 to 500 nanometers when the first non-white colored light is a yellow light.

19. A liquid crystal display (LCD) comprising:
a panel; and
a backlight module disposed on one side of the panel, and comprising:
a housing having a first surface and a second surface;
a plurality of lamp units disposed on the first surface of the housing for generating a first non-white colored light; and
a plurality of LED units disposed between the lamp units for generating a second colored light, wherein the first non-white colored light and the second colored light are mixed to generate a third colored light.
